(19) United States
(12) Patent Application Publication
(10) Pub. No.: US 2024/0015793 A1
(43) Pub. Date: Jan. 11, 2024

(54) PHYSICAL DOWNLINK CONTROL CHANNEL (PDCCH) ORDERED NEIGHBOR CELL PHYSICAL RANDOM ACCESS CHANNEL (PRACH) AND BEAM GROUP BASED TIMING

(71) Applicant: Apple Inc., Cupertino, CA (US)

(72) Inventors: Yushu ZHANG, Beijing (CN); Qiming LI, Beijing (CN); Chunhai YAO, Beijing (CN); Haitong SUN, Cupertino, CA (US); Chunxuan YE, San Diego, CA (US); Oghenekome OTERI, San Diego, CA (US); Hong HE, San Jose, CA (US); Huaning NIU, San Jose, CA (US); Wei ZENG, Saratoga, CA (US); Dawei ZHANG, Saratoga, CA (US); Jie CUI, San Jose, CA (US)

(73) Assignee: Apple Inc., Cupertino, CA (US)

(21) Appl. No.: 17/440,118

(22) PCT Filed: Mar. 30, 2021
(86) PCT No.: PCT/CN2021/083915

§ 371 Date: Oct. 6, 2022

(51) Int. Cl. H04W 74/08; H04W 56/00; H04W 74/00

(52) U.S. Cl. CPC H04W 74/0833; H04W 56/0045; H04W 74/006

(57) ABSTRACT

Some aspects relate to apparatuses and methods for implementing mechanisms for a network to trigger the UE to obtain synchronization with one or more cell neighbors in the network. Some aspects of this disclosure relate to apparatuses and methods for implementing mechanisms for measuring and using TA for a beam group and for uplink signal multiplexing. For example, a UE includes a transceiver configured to wirelessly communicate with a serving cell and a processor communicatively coupled to the transceiver. The processor receives, from the serving cell, a first message indicating Physical Random Access Channel (PRACH) resource configuration associated with a neighbor cell. The processor further receives a second message to trigger transmission of a PRACH message to the neighbor cell. The processor further generates the PRACH message responsive to the second message and according to the PRACH resource configuration cell and transmits the PRACH message to the neighbor cell.

### BACKGROUND

### Field

The described aspects generally relate to mechanisms for a network to trigger a user equipment (UE) to obtain synchronization with the network and to mechanisms for measuring and using Timing Advance (TA) for a beam group.

### Related Art

A base station (for example, an evolved Node B (eNB), a next generation Node B (gNB), etc.) can order a user equipment (UE) to obtain synchronization with the base station. For example, the base station can use Physical Downlink Control Channel (PDCCH) order to trigger the UE. In response, the UE can send a PRACH message to the base station. The base station can use the received PRACH message to determine (e.g., measure) the TA. The base station can send the TA to the UE. The UE can transmit an uplink signal with some offset to compensate propagation delay between the base station and the UE. The UE can change the transmission timing based on, for example, the TA that the UE receives from the base station.

### SUMMARY

Some aspects of this disclosure relate to apparatuses and methods for implementing mechanisms for a network to trigger the UE to obtain synchronization with one or more cell neighbors in the network. Some aspects of this disclosure relate to apparatuses and methods for implementing mechanisms for measuring and using TA for a beam group and for uplink signal multiplexing. For example, some aspects of this disclosure relate to designs for neighbor cell Physical Random Access Channel (PRACH) resource configuration and to designs for Downlink Control Information (DCI) signaling to trigger the UE to obtain synchronization with a neighbor cell. Some aspects of this disclosure relate to designs for a base station to measure TA for a beam group, to designs for control signaling to support beam group based TA, and/or to designs for uplink signal multiplexing (e.g., when different beams are applied).

Some aspects of this disclosure relate to a user equipment (UE). The UE includes a transceiver configured to wirelessly communicate with a serving cell and includes a processor communicatively coupled to the transceiver. The processor receives, using the transceiver and from the serving cell, a first message indicating Physical Random Access Channel (PRACH) resource configuration associated with a neighbor cell. The processor further receives, using the transceiver and from the serving cell, a second message to trigger transmission of a PRACH message to the neighbor cell. The processor further generates, responsive to the second message, the PRACH message according to the PRACH resource configuration associated with the neighbor cell and transmits, using the transceiver, the PRACH message to the neighbor cell.

In some aspects, the processor is further configured to determine, based on the first message, that the PRACH resource configuration associated with the neighbor cell is same as PRACH resource configuration associated with the serving cell.

In some aspects, the processor is further configured to determine, based on the first message, a first set of parameters of the PRACH resource configuration associated with the neighbor cell configured by the serving cell. The processor is further configured to determine, based on the first message, that a second set of parameters of the PRACH resource configuration associated with the neighbor cell is same as corresponding set of PRACH resource configuration associated with the serving cell.

In some aspects, the processor is further configured to determine a first set of parameters of the PRACH resource configuration associated with the neighbor cell based on System Information Block (SIB) of the neighbor cell.

In some aspects, the second message incudes a DCI Format 1-0 including a neighbor cell index associated with the neighbor cell. The neighbor cell index includes a Physical Cell Identifier (PCI) or an identifier (ID) associated with a higher layer configuration for the PRACH resource configuration.

In some aspects, the second message includes a first Physical Downlink Control Channel (PDCCH) message associated with a first Radio Network Temporary Identifier (RNTI) for the neighbor cell and a second PDCCH message associated with a second RNTI associated with a second neighbor cell.

In some aspects, the second message includes one or more of DCI Format 1_0, DCI Format 1_1, or DCI Format 1_2 for indicating a Transmission Configuration Indicator (TCI) associated with the neighbor cell.

In some aspects, the second message includes a Physical Downlink Control Channel (PDCCH) message having a CORESETPoolIndex associated with the neighbor cell for triggering the UE to generate the PRACH.

In some aspects, the second message includes a plurality of DCI signals to trigger the UE to generate a plurality of PRACH messages to transmit to a plurality of neighbor cells. In some aspects, the second message includes a PDCCH message to trigger the UE to generate a plurality of PRACH messages to transmit to a plurality of neighbor cells.

In some aspects, the processor is further configured to receive, using the transceiver, a third message from the neighbor cell. The third message includes a Timing Advance (TA) determined by the neighbor cell.

In some aspects, the processor is further configured to receive, using the transceiver, a third message from the serving cell, where the third message includes an indication of a timing group identifier (ID). The processor is further configured to transmit, using the transceiver and to the serving cell, a plurality of uplink signals associated with the timing group ID having same Timing Advance (TA). In some aspects, the third message includes a TA command Medium Access Control (MAC) Control Element (CE) including the indication of the timing group ID.

In some aspects, the processor is further configured to transmit, using the transceiver and to the serving cell, a granularity for Timing Advance (TA) update. The granularity for TA update can include an amount of time for the UE to change from a first TA associated with a first signal to a second TA associated with a second signal for transmitting the second signal.

In some aspects, the first signal is associated with a first group of signals and the second signal is associated with a second group of signals, and the first TA is different from the second TA. In some aspects, the processor is further configured to transmit, using the transceiver and to the serving cell, the first signal and drop the second signal. Additionally, or alternatively, the processor is further configured to transmit, using the transceiver and to the serving cell, the first signal using the first TA and the second signal using the first TA. Additionally, or alternatively, the processor is further configured to transmit, using the transceiver and to the serving cell, the first signal using the first TA and the second signal using the second TA, where a gap is inserted between the first signal and the second signal.

Some aspects of this disclosure relate to a method including receiving, by a user equipment (UE) and from a serving cell, a first message indicating Physical Random Access Channel (PRACH) resource configuration associated with a neighbor cell. The method further includes receiving, by the UE and from the serving cell, a second message to trigger transmission of a PRACH message to the neighbor cell. The method also includes generating, responsive to the second message, the PRACH message according to the PRACH resource configuration associated with the neighbor cell and transmitting the PRACH message to the neighbor cell.

Some aspects of this disclosure relate to a non-transitory computer-readable medium storing instructions. When the instructions are executed by a processor of a user equipment (UE), the instructions cause the processor to perform operations including, receiving, from a serving cell, a first message indicating Physical Random Access Channel (PRACH) resource configuration associated with a neighbor cell. The operations further include receiving, from the serving cell, a second message to trigger transmission of a PRACH message to the neighbor cell. The operations also include generating, responsive to the second message, the PRACH message according to the PRACH resource configuration associated with the neighbor cell and transmitting the PRACH message to the neighbor cell.

Some aspects of this disclosure relate to a serving cell. The serving cell includes a transceiver configured to wirelessly communicate with a user equipment (UE) and a processor communicatively coupled to the transceiver. The processor transmits, using the transceiver and to the UE, a first message indicating Physical Random Access Channel (PRACH) resource configuration associated with a neighbor cell. The processor further transmits, using the transceiver and to the UE, a second message to trigger the UE to transmit a PRACH message to the neighbor cell. The PRACH message is generated responsive to the second message and according to the PRACH resource configuration associated with the neighbor cell.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing mechanisms for triggering a UE to obtain synchronization with one or more cell neighbors in a network, for measuring and using TA for a beam group, and/or for uplink signal multiplexing, according to some aspects of the disclosure.

FIG. 2 illustrates a block diagram of an example system of an electronic device implementing mechanisms for triggering a UE to obtain synchronization with one or more cell neighbors in a network, for measuring and using TA for a beam group, and/or for uplink signal multiplexing, according to some aspects of the disclosure.

FIG. 3 illustrates an example communication between a UE and a network for triggering a UE to obtain synchronization with one or more cell neighbors in a network, according to some aspects of the disclosure.

FIG. 4 illustrates an example mapping between Random Access Channel (RACH) occasions and Synchronization Signal Block (SSB), according to some aspects of the disclosure.

FIG. 5A illustrates one exemplary timing diagram, according to some aspects of this disclosure.

FIG. 5B illustrates one exemplary system for using different timings for different beams or beam groups, according to some aspects of this disclosure.

FIGS. 6A-6D illustrate exemplary TA command Medium Access Control (MAC) Control Elements (CEs) for indicating one or more groups, according to some aspects of this disclosure.

FIGS. 7A-7D illustrate exemplary methods for transmitting two or more uplink signals with different TAs, according to some aspects of this disclosure.

FIG. 8A illustrates an example method for a system (for example, a UE) supporting mechanisms for obtaining synchronization with one or more cell neighbors in a network, according to some aspects of the disclosure.

FIG. 8B illustrates an example method for a system (for example, a serving cell) supporting mechanisms for triggering a UE to obtain synchronization with one or more cell neighbors in a network, according to some aspects of the disclosure.

FIG. 9 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to apparatuses and methods for implementing mechanisms for a network to trigger the UE to obtain synchronization with one or more cell neighbors in the network. Some aspects of this disclosure relate to apparatuses and methods for implementing mechanisms for measuring and using TA for a beam group and for uplink signal multiplexing (e.g., when different beams are applied).

In some examples, the aspects of this disclosure can be performed by a UE that operates according to Release 17 (Rel-17) new radio (NR) of 5^{th} generation (5G) wireless technology for digital cellular networks as defined by 3rd Generation Partnership Project (3GPP). Additionally, or alternatively, the aspects of this disclosure can be performed by a UE that operates according to the Release 15 (Rel-15) and Release 16 (Rel-16) (or earlier). However, the aspects of this disclosure are not limited to these examples, and one or more mechanisms of this disclosure for triggering the UE to obtain synchronization with one or more cell neighbors in the network, for measuring and using TA for a beam group, and/or for uplink signal multiplexing.

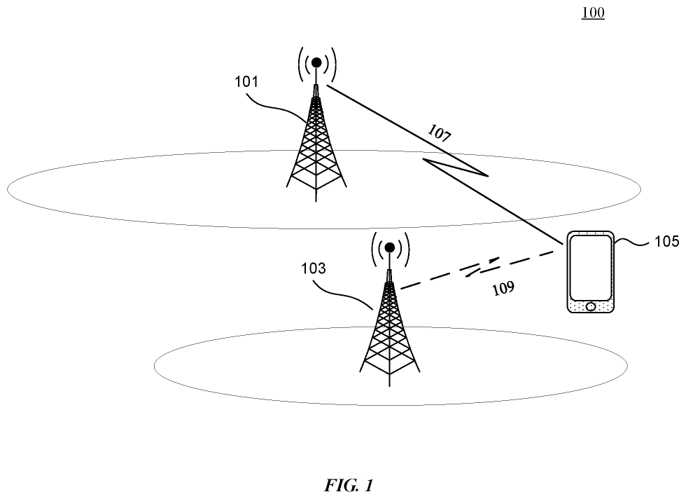

FIG. 1 illustrates an example system 100 implementing mechanisms for triggering a UE to obtain synchronization with one or more cell neighbors in a network, according to some aspects of the disclosure. System 100 of FIG. 1 can also be used for implementing mechanisms for measuring and using TA for a beam group and/or for uplink signal multiplexing, according to some aspects of the disclosure. Example system 100 is provided for the purpose of illustration only and does not limit the disclosed aspects.

System 100 may include, but is not limited to, network nodes (for example, base stations such as eNBs, gNBs) 101 and 103 and electronic device (for example, a UE) 105. Electronic device 105 (hereinafter referred to as UE 105) can include an electronic device configured to operate based on a wide variety of wireless communication techniques. These techniques can include, but are not limited to, techniques based on 3rd Generation Partnership Project (3GPP) standards. For example, UE 105 can include an electronic device configured to operate using Rel-17 or other. UE 105 can include, but is not limited to, as wireless communication devices, smart phones, laptops, desktops, tablets, personal assistants, monitors, televisions, wearable devices, Internet of Things (IoTs), vehicle's communication devices, and the like. Network nodes 101 and 103 (herein referred to as base stations or cells) can include nodes configured to operate based on a wide variety of wireless communication techniques such as, but not limited to, techniques based on 3GPP standards. For example, base stations 101 and 103 can include nodes configured to operate using Rel-17 or other.

According to some aspects, UE 105 and base stations 101 and 103 are configured to implement mechanisms for triggering UE 105 to synchronize with one or more neighbor cells. For example, base station 101 (e.g., the serving cell) can trigger UE 105 to synchronize with base station 103 (e.g., the neighbor cell). According to some aspects, triggering UE 105 to synchronize with base station 103 (e.g., the neighbor cell) can include setting and/or communicating neighbor cell PRACH resource configuration to UE 105. Additionally, or alternatively, triggering UE 105 to synchronize with base station 103 (e.g., the neighbor cell) can include communicating DCI signaling to UE 105 as PDCCH ordered neighbor cell PRACH (e.g., a PDCCH message to order a UE to generate and/or transmit a PRACH message to the neighbor cell).

According to some aspects, UE 105 can be connected to and can be communicating with base station 101 (e.g., the serving cell) using carrier 107. According to some aspects, carrier 107 can include one carrier. Additionally, or alternatively, carrier 107 can include two or more component carriers (CC). In other words, UE 105 can implement carrier aggregation (CA). For example, UE can use multiple carriers for communication with base station 101. According to some aspects, UE 105 can measure one or more carriers (e.g., carrier 107) used for communication with base station 101 (e.g., the serving cell) to determine channel quality information associated with carrier 107. Additionally, or alternatively, UE 105 can detect and measure one or more carriers (for example, carriers 109) associated with base station 103 (e.g., the neighbor cell) to determine channel quality information associated with carrier 109.

In Rel-15 and Rel-16, base station 101 (e.g. the serving cell) can use PDCCH order (e.g., a PDCCH message) to trigger UE 105 to synchronize with base station 101. For example, after UE 105 connects to base station 101, a detection is made (by UE 105 and/or base station 101) that UE 105 and base station 101 are out of synchronization. In response to this determination (and/or receiving downlink (DL) data at base station 101 to be sent to UE 105), base station 101 can send a PDCCH order to UE 105 to trigger UE 105 to send a PRACH message (e.g., a PRACH Preamble). In some examples, base station 101 can trigger UE 105 to send the PRACH message, which is associated with a Synchronization Signal Block (SSB). Base station 101 can use DCI (e.g., DCI Format 1_0) and/or Medium Access Control (MAC) Control Element (CE) as the PDCCH order. In response to receiving the PDCCH order (e.g., the PDCCH message), UE 105 can send the PRACH (e.g., the PRACH Preamble) to base station 101 and base station 101 can send a PRACH Response to UE 105.

After communicating the PRACH message and the PRACH Response, UE 105 and base station 101 can be in synchronization. In some examples, after communicating the PRACH message and the PRACH Response, and before synchronization, UE 105 and base station 101 can also communicate Radio Resource Control (RRC) messages. For example, after sending the PRACH Response, base station 101 can send an RRC Connection Reconfiguration message to UE 105. UE 105 can reconfigure its connection and send an RRC Connection Reconfiguration Complete message back to base station 101 indicating that UE 105's connection has be reconfigured.

In some examples, DCI Format 1_0 used as the PDCCH order can include one or more fields. The one or more fields can include an Identifier for DCI formats. The Identifier for DCI formats can differentiate between DCI Format 0_0 and DCI Format 1_0. In some examples, the Identifier for DCI formats for DCI Format 1_0 is set to value “1”. The one or more fields can further include Frequency domain resource assignment (FDRA). In some examples, the FDRA include one or more bits set to value “1”.

The one or more fields can also include Random Access Preamble index, which can have 6 bits, according to some examples. The Random Access Preamble index can be used for generating the PRACH message. The one or more fields can also include UL/SUL (Uplink/Supplemental UL) Indicator. The one or more fields can also include SS/PBCH (Synchronization Signal/Physical Broadcast Channel) (SSB) index. The SS/PBCH (SSB) index can be used to indicate the SSB associated with the PRACH message. In some examples, if the value of the Random Access Preamble index field is not all zeros, SS/PBCH index field can indicate the SS/PBCH to be used to determine the RACH occasion for the PRACH transmission. Otherwise, SS/PBCH field is reserved.

The one or more fields can also include PRACH mask index. In some examples, if the value of the Random Access Preamble index field is not all zeros, PRACH mask index field can indicate the RACH occasion associated with the SS/PBCH indicated by SS/PBCH index. Otherwise, PRACH mask index field can be reserved.

The one or more fields can also include reserved bits. The aspects of this disclosure are not limited to these examples, and DCI Format 1_0 used as the PDCCH order can include additional or less fields.

As mentioned above, base station 101 can use the PRACH message sent by UE 105 (e.g., the PRACH preamble) to determine (e.g., measure) the TA. Base station 101 can sent the determined TA to UE 105 in, for example, the PRACH Response and/or the RCC Connection Reconfiguration message.

In Rel-17, system 100 can support L1/L2 (Layer 1/Layer 2) centric inter-cell mobility and/or inter-cell multi-TRP (multi-Transmission and Reception Point) operation. According to some examples, for L1/L2 centric inter-cell mobility, base station 101 can use DCI and/or MAC CE to provide a new Transmission Configuration Indicator (TCI) based on a neighbor cell Reference Signal (RS) to UE 105. After receiving and applying the TCI, UE 105 can handover to the neighbor cell (e.g., base station 103). In some examples, UE 105 uses and applies new TAs (e.g., TA measurements) for communicating with the neighbor cell. In some examples, additional synchronization procedure(s) can also be used for the handover operation.

For inter-cell multi-TRP operation, UE 105 may receive multiple downlink (DL) signals from multiple cells and UE 105 may send feedback signals (e.g., Channel State Information (CSI)) back to the cells. In this example, UE 105 may use and apply different TAs for communications with different cells. UE 105 can schedule multiple Physical Downlink Shared Channel (PDSCH) from different cells, which are scheduled by multiple DCIs. In some examples, the DCIs can be carried by Control Resource Set (CORESET) with different CORESETPoolIndex. CORESETs configured with different CORESETPoolIndex can be associated with different cells. In some examples, UE 105 can maintain synchronization to the two or more cells.

As discussed in more detail, to maintain the synchronization to the neighbor cell (e.g., base station 103) for L1/L2 centric inter-cell mobility and inter-cell multi-TRP operation, the aspects of this disclosure provide methods for PDCCH ordered neighbor cell PRACH. According to some aspects, the PDCCH ordered neighbor cell PRACH includes neighbor cell RACH resource configuration and DCI signaling for PDCCH ordered neighbor cell PRACH.

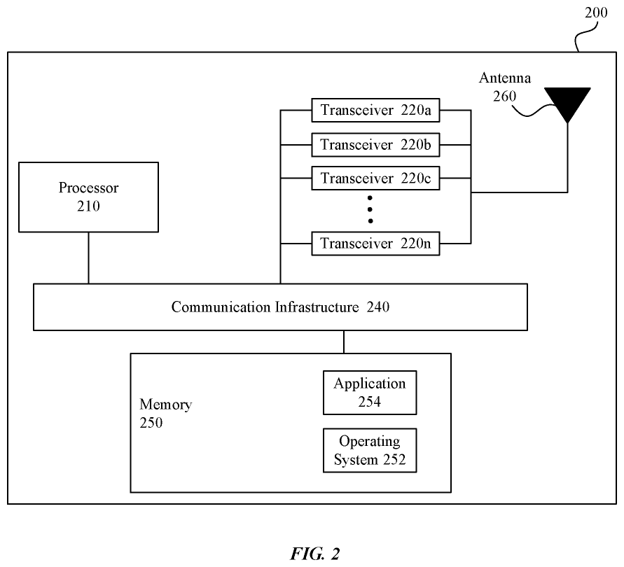

FIG. 2 illustrates a block diagram of an example system 200 of an electronic device implementing mechanisms for triggering a UE to obtain synchronization with one or more cell neighbors in a network, for measuring and using TA for a beam group, and/or for uplink signal multiplexing, according to some aspects of the disclosure. System 200 may be any of the electronic devices (e.g., base stations 101, 103, UE 105) of system 100. System 200 includes processor 210, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to, Siri™, FaceTime™, radio streaming, video streaming, remote control, and/or other user applications.

System 200 can also include communication infrastructure 240. Communication infrastructure 240 provides communication between, for example, processor 210, one or more transceivers 220a-220n, and memory 250. In some implementations, communication infrastructure 240 may be a bus. Processor 210 together with instructions stored in memory 250 performs operations enabling system 200 of system 100 to implement mechanisms for exchanging a searcher number for carrier/cell detection and measurement, as described herein. Additionally, or alternatively, one or more transceivers 220a-220n perform operations enabling system 200 of system 100 to implement mechanisms for triggering a UE to obtain synchronization with one or more cell neighbors in a network, for measuring and using TA for a beam group, and/or for uplink signal multiplexing, as described herein.

One or more transceivers 220a-220n transmit and receive communications signals that support mechanisms for triggering a UE to obtain synchronization with one or more cell neighbors in a network, for measuring and using TA for a beam group, and/or for uplink signal multiplexing, according to some aspects, and may be coupled to antenna 260. Antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a cellular subsystem, a WLAN subsystem, and/or a Bluetooth™ subsystem, each including its own radio transceiver and protocol(s) as will be understood by those skilled arts based on the discussion provided herein. In some implementations, one or more transceivers 220a-220n can include more or fewer systems for communicating with other devices.

In some examples, one or more transceivers 220a-220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, one or more transceivers 220a-220n can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, one or more transceivers 220a-220n can be configured to operate according to one or more of Rel-15, Rel-16, Rel-17, or later of 3GPP standard.

According to some aspects, processor 210, alone or in combination with computer instructions stored within memory 250, and/or one or more transceiver 220a-220n, implements mechanisms for triggering a UE to obtain synchronization with one or more cell neighbors in a network, for measuring and using TA for a beam group, and/or for uplink signal multiplexing, as discussed herein. For example, transceiver 220a can enable connection(s) and communication over a first carrier (for example, carrier 107 of FIG. 1). In this example, transceiver 220a and/or transceiver 220b can enable detecting and/or measuring a second carrier (for example, carrier 109 of FIG. 1). Additionally, or alternatively, wireless system 200 can include one transceiver configured to operate at different carriers. Processor 210 can be configured to control the one transceiver to switch between different carriers, according to some examples. Although the operations discussed herein are discussed with respect to processor 210, it is noted that processor 210, alone or in combination with computer instructions stored within memory 250, and/or one or more transceiver 220a-220n, can implement these operations.

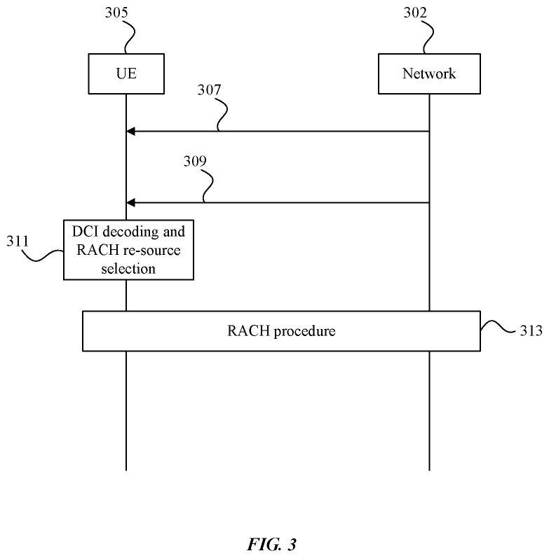

FIG. 3 illustrates an example communication between a UE and a network for triggering a UE to obtain synchronization with one or more cell neighbors in a network, according to some aspects of the disclosure. UE 305 of FIG. 3 can include UE 105 of FIG. 1. Network 302 of FIG. 3 can include a serving cell (e.g., base station 101 of FIG. 1) for UE 305 and one or more neighbor cell (e.g., base station 103 of FIG. 1) for UE 305.

According to some aspects, network 302 can communicate neighbor cell PRACH resource configuration to UE 305. For example, the serving cell of network 302 can transmit message 307 to UE 305, where message 307 can include the PRACH resource configuration associated with the neighbor cell of network 302. In some examples, message 307 can include one or more PRACH resource configurations associated with one or more neighbor cells of network 302. According to some examples, network 302 (e.g., the serving cell of network 302) can send message 307 using one or more RRC messages.

According to some aspect, UE 305 can determine the PRACH resource configuration associated with the neighbor cell of network 302 using different methods. In one exemplary method, UE 305 can assume that the PRACH resource configuration associated with the neighbor cell of network 302 is the same as the PRACH resource configuration associated with the serving cell of network 302. In some examples, the PRACH resource configuration associated with the neighbor cell would be the same as the information configured in RACH-ConfigCommon, RACH-ConfigCommonTwoStepRA, RACH-ConfigDedicated, RACH-ConfigGeneric, and/or RACH-ConfigGenericTwoStepRA determined in, for example, section 6.3.2 of 3GPP Technical Specification (TS) 38.331. In this example, message 307 from network 302 can include one or more parameters set to indicate to UE 305 that the PRACH resource configuration associated with the neighbor cell of network 302 is the same as the PRACH resource configuration associated with the serving cell of network 302. Based on message 307, UE 305 can determine the PRACH resource configuration associated with the neighbor cell of network 302. Additionally, or alternatively, network 302 can use other messages to indicate to UE 305 that the PRACH resource configuration associated with the neighbor cell of network 302 is the same as the PRACH resource configuration associated with the serving cell of network 302.

In another exemplary method, the serving cell of network 302 can configure some (e.g., a set of parameters) of the PRACH resource configuration associated with the neighbor cell of network 302. For example, the serving cell of network 302 can configure some (e.g., a set of parameters) of the PRACH resource configuration associated with the neighbor cell of network 302 using RRC message(s). The parameters configured by the serving cell for the neighbor cell can include, but are not limited to, a subset of or all the parameters configured in RACH-ConfigCommon, RACH-ConfigCommonTwoStepRA, RACH-ConfigDedicated, RACH-ConfigGeneric, RACH-ConfigGenericTwoStepRA. In some examples, network 302 (e.g., the serving cell of network 302) can use message 307 to communicate to UE 305 the configured PRACH resource configuration associated with the neighbor cell of network 302. According to some aspects, for the parameters that are not configured (by, for example, the serving cell), UE 305 can assume that they are the same for both the neighbor cell and the serving cell.

In another exemplary method, UE 305 can derive some of the PRACH resource configuration (e.g., common PRACH resource configuration) associated with the neighbor cell by decoding the neighbor cell's SIB (System Information Block). According to some examples, the neighbor cell's SIB can include block(s) including information used by UE 305 to perform cell selection, re-selection, handover, and the same. In this example, message 307 can include the neighbor cell's SIB received from the neighbor cell of network 302. In some examples, for the dedicated information configured in, for example, RACH-ConfigDedicated, RACH-ConfigGeneric, RACH-ConfigGenericTwoStepRA, UE 305 can use one or more exemplary methods of determining the PRACH resource configuration associated with the neighbor cell of network 302 discussed above.

After sending message 307, network 302 can send message 309 to UE 305 to trigger UE 305 to synchronize with one or more neighbor cells of network 302. In some examples, the serving cell of network 302 sends message 309. In some examples, message 309 can include PDCCH ordered neighbor cell PRACH to trigger UE 305 to synchronize with one or more neighbor cells of network 302. According to some aspects, synchronizing with one or more neighbor cells of network 302 can include UE 305 sending one or more PRACH messages to the one or more neighbor cells. In some examples, message 309 can include a DCI as the PDCCH ordered neighbor cell PRACH

At 311, UE 305 can decode message 309. For example, UE 305 can decode the DCI of message 309 to generate the PRACH message for the neighbor cell(s). Additionally, or alternatively, at 311, UE 305 can select PRACH resource(s) based on message 307 and/or message 309.

After decoding the PDCCH ordered neighbor cell PRACH (e.g., message 309) and/or using configuration(s) from message 307, UE 305 can generate and send the PRACH message (e.g., PRACH Preamble) to the neighbor cell(s) of network 302. According to some aspects, generating and transmitting the PRACH message can be part of RACH procedure 313. In some examples, RACH procedure 313 can further include receiving a PRACH Response from the neighbor cell(s) of network 302. In some aspects, the PRACH Response can include a TA associated with UE 305 for communicating with the neighbor cell(s) of network 302. The neighbor cell(s) of network 302 can determine (e.g., measure) and transmit the TA based on the PRACH message (e.g., PRACH Preamble) received from UE 305.

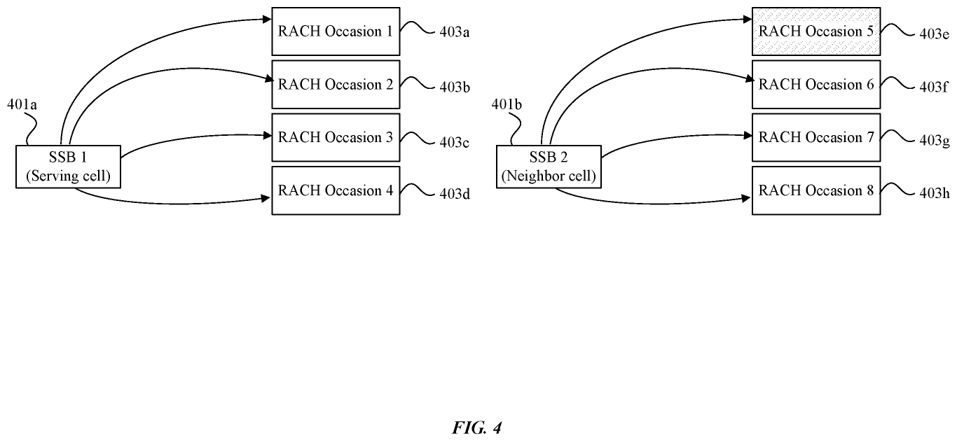

FIG. 4 illustrates an example mapping between RACH occasions and Synchronization Signal Block (SSB), according to some aspects of the disclosure. As discussed above, message 309 of FIG. 3 can include PDCCH ordered neighbor cell PRACH to trigger UE 305 to synchronize with one or more neighbor cells of network 302. In some examples, message 309 can include a DCI as the PDCCH ordered neighbor cell PRACH, which UE 305 can decode. According to some aspects, the DCI signaling to order neighbor cell PRACH may be different with regard to different use cases. In some examples, the use case can include:
Case 1: L1/L2 centric inter-cell mobility,
Case 2: Inter-cell multi-TRP operation,
Case 3: Both case 1 and case 2.

For the above cases, UE 305 determines one or more corresponding RACH occasions associated with the SSB in the neighbor cell and determines one or more preamble indexes for sending the one or more PRACH messages, according to some aspects.

FIG. 4 illustrates an example PDCCH ordered PRACH associated with neighbor cell Synchronization Signal Block (SSB), according to some aspects. In this example, the serving cell (e.g., base station 101 of FIG. 1) can determine a mapping between RACH occasions and SSB. When an SSB is triggered, one or more RACH occasions associated with the triggered SSB can be used by the UE. In some examples, the SSB can be triggered using the SS/PBCH (SSB) index of the DCI signaling. In some examples, the index of the RACH occasion can be indicated by the PRACH mask index of the DCI signaling. In some examples, the RACH occasion indicates the time and frequency resource for the PRACH transmission. For example, SSB1 401a is associated with the serving cell (e.g., base station 101 of FIG. 1) and SSB2 401b is associated with the neighbor cell (e.g., base station 103 of FIG. 1). As illustrated in FIG. 4, RACH occasions 1-4 (403a-403d) are associated with SSB1 401a. Also, RACH occasions 5-8 (403e-403h) are associated with SSB2 401b. In this example, RACH occasion 5 associated with SSB2 is selected for PDCCH ordered PRACH associated with the neighbor cell.

According to some aspects, one or more exemplary DCI signaling can be used for Case 1 (L1/L2 centric inter-cell mobility). In one example, message 309 of FIG. 3 can include a DCI Format 1_0 with some additional information to indicate neighbor cell index. For example, the DCI Format 1_0 can include a neighbor cell index to indicate the neighbor cell for which the UE is to send its PRACH message. In some examples, the neighbor cell index can be a Physical Cell Identifier (PCI).

Additionally, or alternatively, the neighbor cell index can be an identifier (ID) associated with a higher layer configuration for neighbor cell information. In a non-limiting example, the higher layer configuration can indicate a list of four neighbor cells with indexes 0-3. By sending a neighbor cell index of, for example, “0” in the DCI Format, the serving cell indicates to the UE that the ordered PRACH is for the first neighbor cell. As non-limiting examples, the ID associated with a higher layer configuration for neighbor cell information can include, but is not limited to, meaObject ID, SSB-InfoNcell-r16, neighbor cell RACH configuration index, and the like. In some examples, the neighbor cell index can include a default value that indicate the ordered PRACH is for the current cell (e.g., the serving cell).

According to some aspects, the additional information of the DCI Format 1_0 (e.g., the neighbor cell index) can be joined with the SSB index of the DCI Format 1_0. Additionally, or alternatively, the additional information of the DCI Format 1_0 (e.g., the neighbor cell index) can be carried in an independent field of the DCI Format 1_0 (e.g., using the reserved bits). According to some aspects, the indicated SSB index (used for indicating the additional information) in the DCI Format 1_0 can be selected based on the SSB configured for the corresponding neighbor cell.

In some examples, the Random Access Preamble index and/or the PRACH mask index of the DCI Format 1_0 can be selected based on the PRACH/RACH configuration for the corresponding neighbor cell. In one example, if the Random Access Preamble index is set to all value of “0”, then the UE (e.g., UE 305) can randomly select the PRACH/RACH resource corresponding to the indicated neighbor cell. Alternatively, if the Random Access Preamble index is set to all value of “0”, the UE can consider it as an error case.

According to some aspects, for Case 1 (L1/L2 centric inter-cell mobility), the UE (e.g., UE 305) can be configured with different Radio Network Temporary Identifier (RNTI). RNTI can be used to identify one radio channel from other radio channels and/or one user from another users. In a non-limiting example, the UE can be configured with assistant C-RNTI (AC-RNTI) associated with different cells by RRC.

In this example, the PDCCH message associated with different RNTI can be used to trigger the PRACH message for the corresponding cell. For example, message 309 of FIG. 3 can include one or more PDCCH ordered neighbor cell PRACHs. Each of the PDCCH messages can be associated with a corresponding RNTI to trigger the UE's PRACH message for the cell of the corresponding RNTI. In this example, the SSB and PRACH/RACH resources are based on the configuration for the corresponding cell.

According to some aspects, for Case 1 (L1/L2 centric inter-cell mobility), the DCI Format 1_0 can be used for TCI indication. In these examples, the triggered PRACH can be based on the configuration for the cell associated with the indicated TCI. The TCI can be associated with a neighbor cell to trigger PRACH message for the neighbor cell, according to some examples.

According to some examples, when the DCI Format 1_0 can be used for TCI indication, the RACH occasion is selected based on the SSB, which is QCLed with the downlink (DL) RS in the indicated TCI State. For example, as shown in FIG. 4, RACH occasion 5 403e is selected based on SSB2 401b. In some examples, the SSB index of the DCI Format 1_0 is not provided in the DCI. Alternatively, the SSB index can still be provided and the RACH occasion can be counted based on the indicated SSB.

According to some examples, the indicated TCI is applicable after a delay (e.g., X ms) after the UE sends the PRACH message. In some examples, the delay (e.g., X ms) may be predefined or configured by higher layer signaling.

According to some examples, if the network (e.g., the serving cell of network 302) indicates more than one TCI State, which one can be applied for RACH selection can be based on a predefined rule. In a non-limiting example, the TCI with lowest ID can be used for RACH selection. In another example, the TCI selected from the UL TCI pool or the TCI indicated by DCI can be used for RACH selection.

According to some aspects, for Case 1 (L1/L2 centric inter-cell mobility), other DCI Formats (e.g. DCI Format 1_1/1_2) to indicate the TCI can be used to order the PRACH message. In other words, other DCI Formats that are used for TCI indication (e.g. DCI Format 1_1/1_2) can also be used for triggering the PRACH message. In some examples, the indicated TCI can be associated with a neighbor cell to trigger the PRACH message for the neighbor cell. According to some examples, when other DCI Format is used for TCI indication, the RACH occasion is selected based on the SSB, which is QCLed with the DL RS in the indicated TCI State and the SSB index of the DCI Format is not provided in the DCI. Additionally, or alternatively, the Preamble index and/or the PRACH mask index may be configured by higher layer signaling associated with each TCI or the indicated by DCI. In some examples, if the Preamble index and/or the PRACH mask index are not provided, the UE can select a Preamble index and/or a RACH occasion associated with the SSB randomly.

According to some examples, in the DCI, a new field may be introduced to indicate whether the corresponding PRACH message is triggered or not. Alternatively, indicating whether the corresponding PRACH message is triggered or not can be configured by higher layer signaling. In some examples, an action delay for the indicated TCI may be determined by the triggered PRACH message.

According to some aspects, one or more exemplary DCI signaling can be used for Case 2 (inter-cell multi-TRP operation). In some examples, for the inter-cell multi-DCI operation, the exemplary DCI signaling discussed above with respect to Case 1 (L1/L2 centric inter-cell mobility) can be applied for PDCCH ordered neighbor cell PRACH.

Additionally, or alternatively, other exemplary DCI signaling can be used for Case 2 (inter-cell multi-TRP operation). In one example, the network (e.g., the serving cell of network 302 of FIG. 3) can configure an association between CORESETPoolIndex and the neighbor cell by higher layer signaling (e.g., RRC and/or MAC CE). In this example, the PDCCH message is used to trigger the PRACH message based on the RACH occasion and the SSB for the cell associated with the CORESETPoolIndex for the CORESET used to carry the PDCCH message. In a non-limiting example, a first CORESETPoolIndex is associated with the serving cell and a second CORESETPoolIndex is associated with the neighbor cell. When the serving cell triggers the PRACH message based on the first CORESETPoolIndex, the UE knows to send the PRACH message to the serving cell. If the serving cell triggers the PRACH message based on the second CORESETPoolIndex, the UE knows to send the PRACH message to the neighbor cell.

The RACH procedure associated with a CORESETPoolIndex can be independent. In other words, the RACH procedure associated with the CORESETPoolIndex of the serving cell can be independent of the RACH procedure associated with the CORESETPoolIndex of the neighbor cell. This example includes multi-RACH procedure, which includes one RACH procedure per cell. In one example, if there is an ongoing Random Access procedure that is triggered by a PDCCH order while the UE receives another PDCCH order associated with the same CORESETPoolIndex indicating the same Random Access Preamble index, PRACH mask index ,and uplink carrier, the Random Access procedure is considered as the same Random Access procedure as the ongoing one and not initialized again.

In addition, to support cross CORESETPoolIndex triggering, the DCI Format can include one or more additional fields to indicate whether this PRACH message is based on cell associated with current CORESETPoolIndex or another CORESETPoolIndex.

In some examples, for the inter-cell multi-DCI operation (Case 2), the exemplary DCI signaling discussed above with respect to Case 1 (L1/L2 centric inter-cell mobility) can be combined with the CORESETPoolIndex. In this examples, a default mode can be used to trigger the PRACH message corresponding to the cell associated with the CORESETPoolIndex.

According to some aspects, to support both inter-cell mobility and inter-cell multi-TRP (Case 3), the network (e.g., the serving cell of network 302 of FIG. 3) has the flexibility to order multiple PRACH messages.

In some examples, the exemplary DCI signaling discussed above with respect to Case 1 (L1/L2 centric inter-cell mobility) and Case 2 (inter-cell multi-TRP operation) can be reused for Case 3 with the UE being able to maintain more than one RACH procedure. In this example, the network (e.g., the serving cell of network 302 of FIG. 3) can order multiple PRACH messages using multiple DCIs. In one example, if there is an ongoing Random Access procedure that is triggered by a PDCCH order while the UE receives another PDCCH order indicating the same Random Access Preamble index, PRACH mask index, and uplink carrier, the Random Access procedure associated with the same physical cell is considered as the same Random Access procedure as the ongoing one and is not initialized again.

Additionally, or alternatively, the network (e.g., the serving cell of network 302) can trigger more than one PRACH message based on a single PDCCH message. In this example, the exemplary DCI signaling discussed above with respect to Case 1 (L1/L2 centric inter-cell mobility) and Case 2 (inter-cell multi-TRP operation) can be extended for Case 3 to support multi-PRACH ordering. In some examples, the network (e.g., the serving cell of network 302) can be configured more than one cell index (of the method discussed with respect to Case 1 above) in the triggering PDCCH. In some examples, some RNTI (of the method discussed with respect to Case 1 above) can indicate multiple cell. In another example, one TCI codepoint can indicate TCI States (of the method discussed with respect to Case 1 above) associated with one or multiple cells. When multiple cells are indicated, the UE can send more than one PRACH message associated with the indicated cells. In some examples, one field can indicate whether UE sends the PRACH message for the cells associated with both CORESETPoolIndex (of the methods discussed with respect to Case 2 above).

Although some examples are discussed with one serving cell and one neighbor cell, the aspects of this disclosure are not limited to these examples. The methods for communicating and using neighbor cell PRACH resource configuration and/or method for communicating and using DCI signaling can be used for more than one neighbor cell. For example, methods for Cases 1 and 3 discussed above (e.g., L1/L2 centric inter-cell mobility) can be applied to a plurality of neighbor cells.

Returning to FIG. 1, system 100 can also be used for implementing mechanisms for measuring and using TA for a beam group and/or for uplink signal multiplexing (e.g., when different beams are applied), according to some aspects of the disclosure.

In some examples, UE 105 transmits an uplink signal to base station 101 (e.g., the serving cell) and/or to base station 103 (e.g., the neighbor cell) with some offset to compensate for propagation delay between UE 105 and base station 101 and/or between UE 105 and base station 103, respectively. In some examples, UE 105 can determine the time offset based on the TA received from the corresponding base station.

In some examples, base station 101 (and/or base station 103) receives an uplink signal (e.g., the PRACH message discussed above) from UE 101. Base station 101 (and/or base station 103) determines the TA based on the received uplink signal. Base station 101 (and/or base station 103) communicates the TA to UE 105. In some examples, the TA is based on a round trip delay between UE 105 and base station 101 (and/or base station 103). In some examples, the TA is communicated to UE 101 using a TA command indicated in MAC CE. Additionally, or alternatively, UE 105 can autonomously determine the time offset and adjust its transmission timing based on one or more downlink measurement(s).

In some examples, some component carriers (CCs) in a group can share the same TA, which are configured in a TA group (TAG). In these examples, an identifier of the TAG (TAG-Id) can be configured in servingCellConfig.

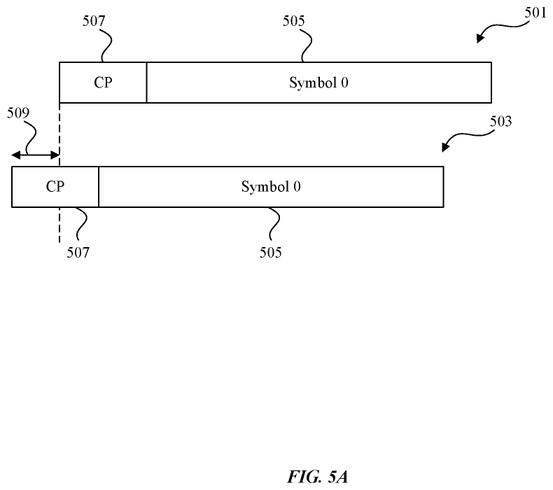

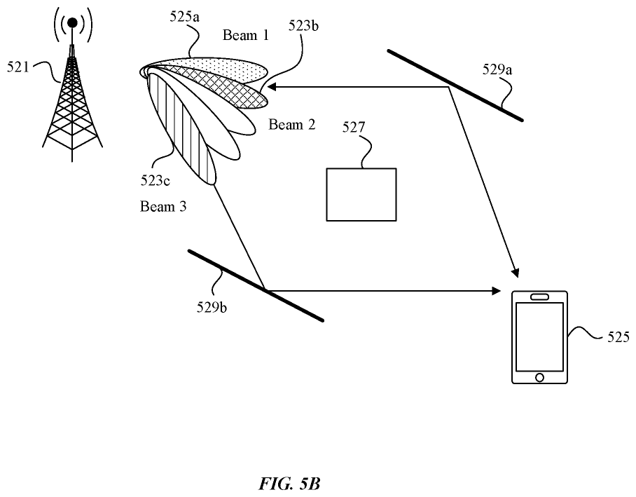

FIG. 5A illustrates one exemplary timing diagram, according to some aspects of this disclosure. Timing 501 illustrates a network timing for a frame including symbol 505 and cyclic prefix (CP) 507. Timing 503 illustrates a UE timing to transmit the frame compared to network timing 501. In this example, the UE (e.g., UE 105 of FIG. 1) can use time offset 509 to adjust its transmission timing. As discussed above, time offset 509 can be determined based on the TA communicated by the base station. In a non-limiting example, time offset 509 can be 0.5*TA. However, time offset 509 can include other values. In another examples, the (e.g., UE 105) can autonomously determine time offset 509 based on one or more downlink measurement(s).

FIG. 5B illustrates one exemplary system for using different timings for different beams or beam groups, according to some aspects of this disclosure. As illustrated in FIG. base station 521 (e.g., a serving cell or a neighbor cell) and UE 525 can communicate using three beams 523a-523b. In the example of FIG. 5B, beams 523a and 523b can be reflected from surface 529a. Also, in this example, beam 523c can be reflected from surface 529b. In this example, beams 523a and 523b can have similar paths between base station 521 and UE 525, and therefore, similar (e.g., substantially the same) propagation delay. But beams 523a and 523b and beam 523c can have different paths between base station 521 and UE 525, and therefore, different propagation delays. In some examples, beams 523a-c can be from the same TRP or different TRPs. In this example, structure 527 can block other beams, including beam 523b, from base station 521.

In some examples, when beam switching happens, UE 525 may change the transmission timing with a multiple (X) of Ts (e.g., X*Ts), where Ts is the duration of a sample as defined in, for example, 3GGP TS 38.211. In a non-limiting example, for multi-TRP operation (e.g., above 52.6 GHz system and/or non-terrestrial network) the value of the multiple X may be large for some beam switching cases. In some examples, if two beams are highly correlated, the value of the multiple X may be small. And, if the two beams are not highly correlated, the value of the multiple X may be large. In the example of FIG. 5B, beams 523a and 523b can share the same (or substantially the same) timing (e.g., TA). However, beam 523c can have different timing (e.g., TA) compared to beams 523a and 523b.

Some aspects of this disclosure are directed to methods and apparatuses for implementing mechanisms for a base station (e.g., the serving cell or the neighbor cell) to determine (e.g., measure) the TA for a beam group. According to some aspects, the base station (e.g., the serving cell and/or the neighbor cell) can trigger multiple PRACH message s associated with different SSBs based on one DCI. By triggering multiple PRACH messages using one DCI, the base station can reduce signaling overhead. In some examples, the multiple PRACH messages can be for different beams, different beam groups, and/or different cells (serving and/or neighbor cells).

In one example, the base station can use DCI Format 1_0 to trigger PRACH messages (e.g., PRACH resources). In this example, additional fields can be added to the DCI Format 1_0 to provide the additional information needed to trigger multiple PRACH messages. For example, if DCI Format 1_0 is used to trigger a second PRACH message, the DCI Format 1_0 can include an additional Random Access Preamble index for the second PRACH message. In some examples, if an additional Random Access Preamble index is not provided, the second PRACH message can share the same Random Access Preamble index with the first PRACH message.

Additionally, or alternatively, if DCI Format 1_0 is used to trigger a second PRACH message, the DCI Format 1_0 can include an additional SS/PBCH index for the second PRACH message. Additionally, or alternatively, if DCI Format 1_0 is used to trigger a second PRACH message, the DCI Format 1_0 can include an additional PRACH mask index for the second PRACH message. In some examples, if an additional PRACH mask index is not provided, the second PRACH message can share the same PRACH mask index with the first PRACH message.

According to some aspects, one or more RRC parameters can be used and/or introduced to enable using on DCI to trigger multiple PRACH messages associated with different SSBs. In some examples, when the one or more RRC parameters are enabled, the additional field(s) can be present in the DCI.

Although the above example is provided for two PRACH messages, the aspects of this disclosure can be applied to any number of PRACH messages.

Some aspects of this disclosure are directed to methods and apparatuses for implementing mechanisms for generating and communicating control signaling to support beam group based TA measurement. In some examples, correlated beams can share the same or substantially the same TA. In some examples, the uncorrelated beams can share different TAs.

According to some aspects, for uplink signals (and/or uplink beams) with different uplink Transmission Configuration Indicator (TCI) and/or spatial relation information, the base station (e.g., the serving cell and/or the neighbor cell) can indicate a timing group ID. In some examples, for uplink signals that share the same timing group ID, the same TA can be applied. In this example, the base station can determine and communicate the same TA to the UE (and/or a plurality of UEs) for uplink signals that share the same timing group ID.

In some examples, for Physical Uplink Control Channel (PUCCH), the timing group ID may be configured in TCI (e.g., UL TCI and/or spatial relation information). However, if TCI is not indicated, the UE may assume a default value of the timing group ID (e.g. group ID=0).

Additionally, or alternatively, the timing group ID may be configured per PUCCH resource or per PUCCH resource group. In some examples, the timing group ID may be updated by MAC CE.

According to some aspects, for Sounding Reference Signal (SRS), the timing group ID may be configured in a SRS resource set or in a SRS resource. In some examples, the timing group ID may be updated by MAC CE.

According to some aspects, for Physical Uplink Shared Channel (PUSCH), the timing group ID can be based on the timing group ID for the SRS resource(s) indicated by SRI(s).

In one example, the timing group ID can be provided in TCI by RRC and/or MAC CE.

Below provides a non-liming example for TCI-State and PUCCH-spatialRelationInfo update. In this non-liming example, “groupId” is provided in the TCI-State and PUCCH-spatialRelationInfo:

| | |
|---|---|
| TCI-State ::= | SEQUENCE { |
| tci-StateId | TCI-StateId, |
| groupId | INTEGER(0..maxNrofGroups-1) OPTIONAL,-- |

| Need S | |
|---|---|
| <unrelated elements omitted> | |
| ... | |
| } | |
| PUCCH-SpatialRelationInfo ::= | SEQUENCE { |
| pucch-SpatialRelationInfoId | PUCCH-SpatialRelationInfoId, |
| <unrelated elements omitted> | |
| groupId | INTEGER(0..maxNrofGroups-1) |

OPTIONAL, - Need S
}

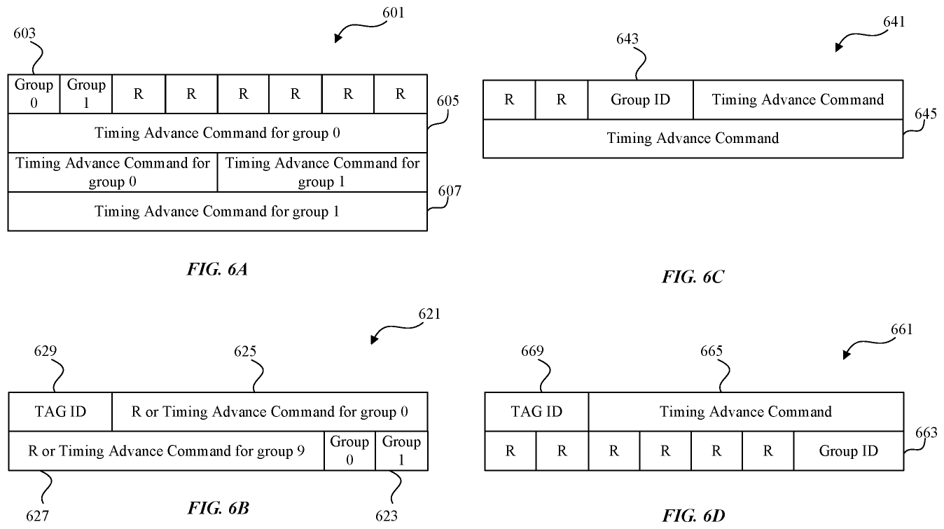

According to some aspects, the MAC CE for the TA command can be updated to include the timing group ID. FIGS. 6A-6D illustrate exemplary TA command MAC CEs for indicating one or more groups, according to some aspects of this disclosure. In some examples, a TA command MAC CE can be used to indicate the TA for all the groups. In another example, a TA command MAC CE can be used to indicate the TA for each group.

In one example, a bit map can be used to indicate the timing group ID, where each bit corresponds to a group. In this example, the indicated TA command can be applied for multiple groups. One MAC CE may update the TA(s) for multiple groups. For example, FIG. 6A illustrates TA command MAC CE 601 that includes timing group ID 603 for Groups 0 and 1. In one example, timing group ID 603 can be a bit map, where each bit corresponds to a group (e.g., Group 0, Group 1, etc.) In this example, TA command MAC CE 601 includes TA command for group 0 605 and TA command for group 1 607.

Additionally, or alternatively, a differential TA for other groups may be reported with the TA for group 1 as a reference, for overhead reduction. For example, FIG. 6B illustrates TA command MAC CE 621 that includes TAG ID (or TAG Id) 629 and timing group ID 623 for Groups 0 and 1. In one example, timing group ID 603 can be a bit map, where each bit corresponds to a group. In this example, TA command MAC CE 621 includes TA command for group 0 625 and TA command for group 1 627. In this example, TA command for group 0 625 can be a differential TA for group 0 reported with the TA for group 1 627 as a reference.

In another example, absolute value of the timing group ID can be used (e.g., instead of a bit map.) In this examples, one TA command MAC CE can update the TA for a group. For example, FIG. 6C illustrates TA command MAC CE 641 that includes timing group ID 643 for one group (e.g., Group 0 or Group 1). In this example, TA command MAC CE 641 includes TA command 645 for one group (e.g., Group 0 or Group 1).

Additionally, or alternatively, a differential TA for other groups may be reported with the TA for group 1 as a reference, for overhead reduction. For example, FIG. 6D illustrates TA command MAC CE 661 that includes TAG ID (or TAG Id) 669 and timing group ID 663 for one group (e.g., Group 0 or Group 1). In this example, TA command MAC CE 661 includes TA command 665 for one group (e.g., Group 0 or Group 1). In this example, TA command 665 can be a differential TA reported with the TA for group 1 as a reference.

Alternatively, the timing group ID can be indicated by the DCI used to schedule the PDSCH for MAC CE.

Additionally, some aspects of this disclosure are directed to methods and apparatuses for implementing mechanisms for uplink signal multiplexing (e.g., when different beams are applied). In some examples, the UE cannot change the TA symbol by symbol. In some examples, for the uplink signal multiplexing, the UE considers its capability and potential TA differences.

According to some aspects, the UE can report to a base station (e.g., the serving cell and/or the neighbor cell) a granularity (e.g., a minimum granularity) for TA update. The granularity for TA update can include the amount of time needed by the UE to change from a first TA associated with a first signal to a second TA associated with a second signal to transmit the second signal. In some examples, the granularity can be defined at symbol level and the reported granularity can be based on a number of symbols. Additionally, or alternatively, the granularity can be defined at slot level. For example, the UE can update its TA per slot based on the TAs (e.g., TA measurements) the UE receives from the base station. The granularity (at symbol level and/or slot level) can be defined based on a reference subcarrier spacing and/or a current subcarrier spacing.

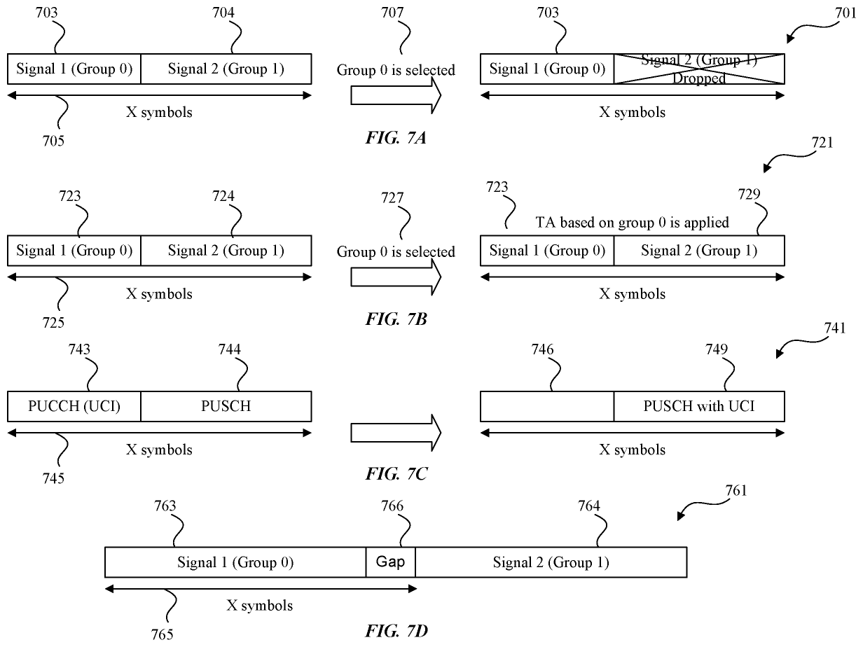

According to some aspects, for uplink multiplexing, if the UE is transmitting two or more signals with different TAs with a number of symbols (e.g., X symbols), the UE can use one or more of the methods discussed in more detail below. In some examples, the UE can use one or more beams for transmitting the two or more signals with different TAs. FIGS. 7A-7D illustrate exemplary methods for transmitting two or more uplink signals with different TAs, according to some aspects of this disclosure.

In one example, transmitting two or more signals with different TAs can be considered as an error case and a scheduling restriction is applied to the UE (by, for example, the base station).

In another example, the UE only transmits the uplink signal from one group. As discussed above, each group can be a set of uplink signals of a TCI and/or spatial relation information. Each group of the uplink signal can have its associated timing group ID and TA. FIG. 7A illustrates this exemplary method for transmitting uplink signals with different TAs, according to some aspects of this disclosure. As illustrated in FIG. 7A, two uplink signals 703 and 704 from two groups (Group 0 and Group 1) are to be transmitted within a number of symbols 705 (e.g., X symbols). In this example, Group 0 and Group 1 have different TAs. In this example, the UE transmits the uplink signal from one group. The UE selects Group 0 (at 707) and only transmits signal 703 for Group 0 in 701 and drops (e.g., does not transmit) signal 704 from Group 1.

In another example, the UE transmits uplink signals from multiple groups, but only applies the TA from one group. As discussed above, each group of the uplink signal can have its associated timing group ID and TA. FIG. 7B illustrates this exemplary method for transmitting uplink signals with different TAs, according to some aspects of this disclosure. As illustrated in FIG. 7B, two uplink signals 723 and 724 from two groups (Group 0 and Group 1) are to be transmitted within a number of symbols 725 (e.g., X symbols). In this example, Group 0 and Group 1 have different TAs. In this example, the UE transmits both uplink signals but applies the TA from one of the groups. The UE selects Group 0 (at 727) and determines and uses the TA of Group 0 for transmitting the signals in 721. The UE transmits, at 721, signal 721 with the TA of Group 0 and signal 729 (the signal for Group 1) with the TA of Group 0. Alternatively, the UE can transmit, at 721, signal 721 with the TA of Group 1 and signal 729 (the signal for Group 1) with the TA of Group 1.

In the examples of FIGS. 7A and 7B, the UE can select Group 0 at 707 or 727 based on one or more criteria. In one example, the selected group can be a predefined group. In a non-liming example, the predefined group can be a group with the lowest timing group ID. In another non-liming example, the predefined group can be a group with the highest timing group ID. In another example, the selected group can be indicated by DCI and/or configured by higher layer signaling received from, for example, the base station (e.g., the serving cell and/or the neighbor cell). In another example, the selected group can be determined by a priority of the uplink signals (e.g., signals 703 and 704 or signals 723 and 724). In some examples, the priority can be predefined. In a non-liming example, PUSCH can have more priority than PUCCH, which can have more priority than SRS.

In another example, the UE multiplexes the Uplink Control Information (UCI) in PUCCH by PUSCH when PUCCH and PUSCH are to be transmitted in different symbols with different TA. FIG. 7C illustrates this exemplary method for transmitting uplink signals with different TAs, according to some aspects of this disclosure. As illustrated in FIG. 7C, UCI in PUCCH 743 and PUSCH 744 are to be transmitted with different TAs within a number of symbols 745 (e.g., X symbols). In some examples, PUCCH 743 is associated with Group 0 and PUSCH 744 is associated with Group 1. In this example, the UE multiplexes the UCI with PUSCH (signal 749—e.g., Group 1) to transmit at 741. In some examples, nothing is transmitted in 746. In some examples, the UE uses the TA for PUSCH to transmit the UCI multiplex with PUSCH (signal 749). Alternatively, the UE can use the TA for PUCCH to transmit the UCI multiplex with PUSCH (signal 749).

In another example, for uplink signals with different TAs across the X symbols, a gap may be inserted to avoid overlap between the two signals. FIG. 7D illustrates this exemplary method for transmitting uplink signals with different TAs, according to some aspects of this disclosure. As illustrated in FIG. 7D, the UE can transmit 761 signal 763 (associated with Group 0) and signal 764 (associated with Group 1) with a gap 766. In this example, Group 0 and Group 1 have different TAs. In this example, signal 763 and gap 766 are transmitted across X symbols 765. Gap 766 can give enough time to the UE to change from the TA associated with Group 0 to the TA associated with Group 1 for transmitting signal 764. In some examples, a duration (e.g., a minimum duration) of gap 766 can be predefined. In another example, the duration of gap 766 may be reported by the UE to the base station (e.g., the serving cell and/or the neighbor cell).

Although some examples are discussed above with respect to uplink signals, the aspect of this disclosure can be applied to uplink beams. For example, the aspects of this disclosure discussed with respect to FIGS. 6A-6D and/or FIGS. 7A-7D can also be applied to uplink beams.

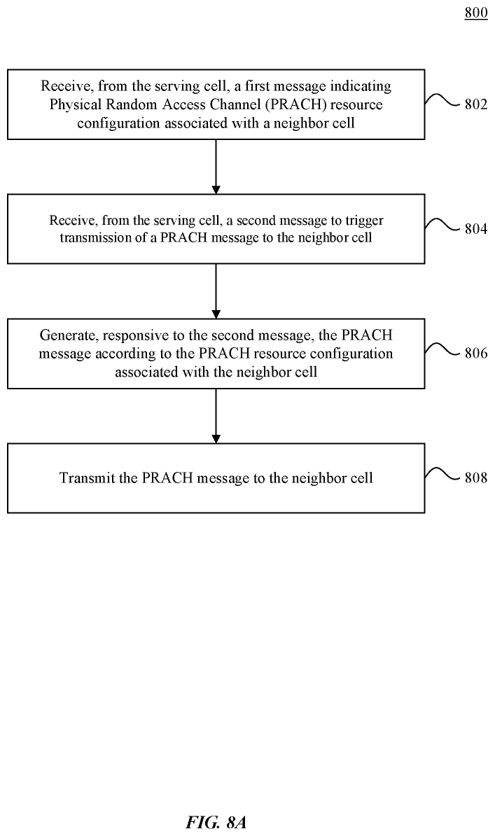

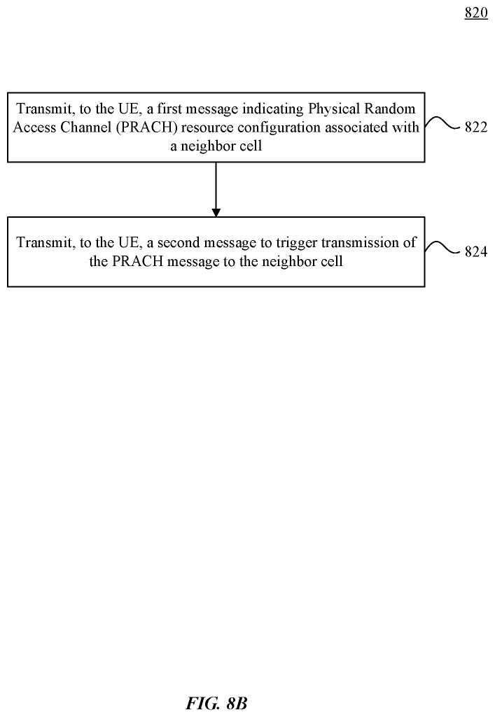

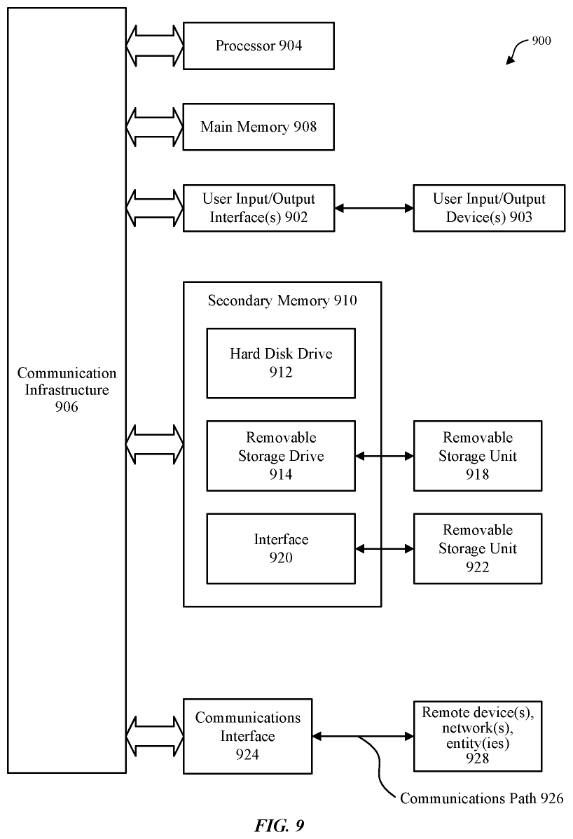

FIG. 8A illustrates example method 800 for a system (for example, a UE) supporting mechanisms for obtaining synchronization with one or more cell neighbors in a network, according to some aspects of the disclosure. As a convenience and not a limitation, FIG. 8A may be described with regard to elements of FIGS. 1-7. Method 800 may represent the operation of an electronic device (for example, UE 105 of FIG. 1 and/or UE 305 of FIG. 3) implementing mechanisms for obtaining synchronization with one or more cell neighbors in a network. Method 800 may also be performed by system 200 of FIG. 2 and/or computer system 900 of FIG. 9. But method 800 is not limited to the specific aspects depicted in those figures and other systems may be used to perform the method as will be understood by those skilled in the art. It is to be appreciated that not all operations may be needed, and the operations may not be performed in the same order as shown in FIG. 8A.

At 802, a first message is received. For example, the UE (e.g., UE 305 of FIG. 3) receives, from a serving cell (e.g., the serving cell of network 302), the first message (e.g., message 307 of FIG. 3). The first message can indicate Physical Random Access Channel (PRACH) resource configuration associated with a neighbor cell (e.g., the neighbor cell of network 302 of FIG. 3).

According to some aspects, operation 802 can further include determining (by, for example, the UE), based on the first message, that the PRACH resource configuration associated with the neighbor cell is same as PRACH resource configuration associated with the serving cell. Additionally, or alternatively, operation 802 can further include determining (by, for example, the UE), based on the first message, a first set of parameters of the PRACH resource configuration associated with the neighbor cell that is configured by the serving cell and determining, based on the first message, that a second set of parameters of the PRACH resource configuration associated with the neighbor cell is same as corresponding set of PRACH resource configuration associated with the serving cell.

According to some aspects, operation 802 can further include determining (by, for example, the UE) a first set of parameters of the PRACH resource configuration associated with the neighbor cell based on System Information Block (SIB) of the neighbor cell. The UE can further determine that a second set of parameters of the PRACH resource configuration associated with the neighbor cell is the same as the corresponding parameters of the PRACH resource configuration associated with the serving cell. Additionally, or alternatively, the UE can further determine the second set of parameters of the PRACH resource configuration associated with the neighbor cell as configured by the serving cell and transmitted in the first message.

At 804, a second message is received. For example, the UE receives the second message (e.g., message 309 of FIG. 3) from the serving cell. In some examples, the second message is to trigger generation and transmission of a PRACH message to the neighbor cell. In some examples, the second message includes the DCI signaling discussed above with respect to Cases 1-3 discussed above.

In some examples, the second message can include a DCI Format 1_0 including a neighbor cell index associated with the neighbor cell. The neighbor cell index can include a PCI or an ID associated with a higher layer configuration for the PRACH resource configuration. In some examples, the second message can include a first PDCCH message associated with a first RNTI for the neighbor cell and a second PDCCH message associated with a second RNTI associated with a second neighbor cell.

In some examples, the second message can include one or more of DCI Format 1_0, DCI Format 1_1, or DCI Format 1_2 for indicating a TCI associated with the neighbor cell. In some examples, the second message can include a PDCCH message having a CORESETPoolIndex associated with the neighbor cell for triggering the UE to generate the PRACH message. In some examples, the second message can include a first PDCCH message having a first CORESETPoolIndex associated with the serving cell and a second PDCCH message having a second CORESETPoolIndex associated with the neighbor cell for triggering the UE to generate the PRACH message.

In some examples, the second message can include a plurality of DCI signals (e.g., a plurality of DCI Formats) to trigger the UE to generate a plurality of PRACH messages to transmit to a plurality of neighbor cells. In some examples, the second message can include a PDCCH message to trigger the UE to generate a plurality of PRACH messages to transmit to a plurality of neighbor cells.

At 806, the PRACH message is generated based, at least, on the first message and the second message. For example, the PRACH message is generate responsive to the second message and according to the PRACH resource configuration associated with the neighbor cell. For example, the UE can generate the PRACH based, responsive to the second message and according to the PRACH resource configuration associated with the neighbor cell. In some examples, the UE is configured to generate a plurality of PRACH messages based, at least, on the first message and the second message (e.g., responsive to the second message and according to the PRACH resource configuration associated with the neighbor cell). In some examples, generating the PRACH message (or the plurality of PRACH messages) can include or be part of operation 311 of FIG. 3. For examples, operation 806 can include decoding the second message (e.g., message 309) and selecting the PRACH resource(s) (and/or the PRACH resource configuration) based on the first and second messages (e.g., message 307 and/or message 309 of FIG. 3.)

At 808, the generated PRACH message is transmitted to the neighbor cell. For example, the UE can send the PRACH message to the neighbor cell during RACH procedure 313 of FIG. 3. In some examples, the UE can send a plurality of PRACH messages to corresponding plurality of neighbor cells during operation 808 and RACH procedure 313 of FIG. 3.

According to some aspects, method 800 can further include receiving a third message from the neighbor cell, where the third message includes a TA determined by the neighbor cell.

In addition to, or in alternate to, operations 802-808 of FIG. 8A for obtaining synchronization with one or more cell neighbors in a network, method 800 can include operations for implementing mechanisms for measuring and using TA for a beam group and/or for uplink signal multiplexing (e.g., when different beams are applied), as discussed above with respect to FIGS. 6A-6D and 7A-7D.

For example, method 800 can include receiving a message from the serving cell (and/or the neighbor cell), the message includes an indication of a timing group identifier (ID). In some aspects, the message includes a TA command MAC CE including the indication of the timing group ID. However, the aspects of this disclosure can include other messages including the indication of the timing group ID, as discussed above with respect to, for example, FIGS. 6A-6D. In some aspects, after receiving (and/or based on) the message including the timing group ID, the UE can transmit to the serving cell (and/or the neighbor cell) a plurality of uplink signals associated with the timing group ID having same TA.

Additionally, or alternatively, method 800 can include transmitting to the serving cell (and/or the neighbor cell) a granularity for TA update, as discussed above with respect to FIGS. 7A-7D. The granularity for TA update can include an amount of time for the UE to change from a first TA associated with a first signal to a second TA associated with a second signal for transmitting the second signal.

In some examples, the first signal is associated with a first group of signals and the second signal is associated with a second group of signals and the first TA is different from the second TA. According to some aspects, method 800 can include transmitting to the serving cell (and/or the neighbor cell) the first signal and dropping the second signal. According to some aspects, method 800 can include transmitting to the serving cell (and/or the neighbor cell) the first signal using the first TA and the second signal using the first TA. According to some aspects, method 800 can include transmitting to the serving cell (and/or the neighbor cell) the first signal using the first TA and the second signal using the second TA. In this example, method 800 can also include inserting a gap between the first signal and the second signal.

FIG. 8B illustrates example method 820 for a system (for example, a serving cell) supporting mechanisms for triggering a UE to obtain synchronization with one or more cell neighbors in a network, according to some aspects of the disclosure. As a convenience and not a limitation, FIG. 8B may be described with regard to elements of FIGS. 1-7. Method 820 may represent the operation of an electronic device (for example, base station 105 of FIG. 1 and/or the serving cell of network 302 of FIG. 3) implementing mechanisms for triggering a UE to obtain synchronization with one or more cell neighbors in a network. Method 820 may also be performed by system 200 of FIG. 2 and/or computer system 900 of FIG. 9. But method 820 is not limited to the specific aspects depicted in those figures and other systems may be used to perform the method as will be understood by those skilled in the art. It is to be appreciated that not all operations may be needed, and the operations may not be performed in the same order as shown in FIG. 8B.

At 822, a first message is transmitted. For example, the serving cell (e.g., the serving cell of network 302 of FIG. 3 and/or base station 101) transmits, to a UE (e.g., UE 105 of FIG. 1 and/or UE 305 of FIG. 3), the first message (e.g., message 307 of FIG. 3). The first message can indicate Physical Random Access Channel (PRACH) resource configuration associated with a neighbor cell (e.g., the neighbor cell of network 302 of FIG. 3). The first message is similar to the first message discussed above with respect to FIGS. 3 and 8A.

In some aspects, the serving cell can generate the first message based on the information that the serving cell receives from and/or determines for the neighbor cell.

At 824, a second message is transmitted. For example, the serving cell transmits the second message (e.g., message 309 of FIG. 3) to the UE. In some examples, the second message is to trigger generation and transmission of a PRACH message to the neighbor cell. In some examples, the second message is similar to the second message discussed above with respect to FIGS. 3 and 8A and can include the DCI signaling discussed above with respect to Cases 1-3. The PRACH message is generated based, at least, on the first message and the second message, as discussed above. For example, the PRACH message is generated responsive to the second message and according to the PRACH resource configuration associated with the neighbor cell.

In some aspects, the serving cell can generate the second message based on and/or in response to determining an L1/L2 centric inter-cell mobility of the UE. For example, in response to determining that the UE is to handover to the neighbor cell, the serving cell can generate and/or transmit the second message. Additionally, or alternatively, the serving cell can generate the second message based on and/or in response to inter-cell multi-TRP operation.

In addition to, or in alternate to, operations 822-824 of FIG. 8B for triggering the UE to obtain synchronization with one or more cell neighbors in the network, method 820 can include operations for implementing mechanisms for measuring and using TA for a beam group and/or for uplink signal multiplexing (e.g., when different beams are applied), as discussed above with respect to FIGS. 6A-6D and 7A-7D.

For example, method 820 can include transmitting a message (from the serving cell and/or the neighbor cell) to the UE. The message can include an indication of a timing group identifier (ID). In some aspects, the message includes a TA command MAC CE including the indication of the timing group ID. However, the aspects of this disclosure can include other messages including the indication of the timing group ID, as discussed above with respect to, for example, FIGS. 6A-6D. In some aspects, after transmitting the message including the timing group ID, the serving cell (and/or the neighbor cell) can receive (from the UE) a plurality of uplink signals associated with the timing group ID having same TA.

Additionally, or alternatively, method 820 can include receiving (at the serving cell and/or the neighbor cell), from the UE, a granularity for TA update, as discussed above with respect to FIGS. 7A-7D. The granularity for TA update can include an amount of time for the UE to change from a first TA associated with a first signal to a second TA associated with a second signal for transmitting the second signal. In some examples, the first signal is associated with a first group of signals and the second signal is associated with a second group of signals and the first TA is different from the second TA.

According to some aspects, method 820 can include receiving (at the serving cell and/or the neighbor cell), from the UE, the first signal where the second signal is drop. According to some aspects, method 820 can include receiving (at the serving cell and/or the neighbor cell), from the UE, the first signal transmitted using the first TA and the second signal transmitted using the first TA. According to some aspects, method 820 can include receiving (at the serving cell and/or the neighbor cell), from the UE, the first signal transmitted using the first TA and the second signal transmitted using the second TA. In this example, a gap can is inserted between the first signal and the second signal.

Various aspects can be implemented, for example, using one or more computer systems, such as computer system 900 shown in FIG. 9. Computer system 900 can be any well-known computer capable of performing the functions described herein such as devices 101, 105 of FIG. 1, 200 of FIG. 2, and/or 302, 305 of FIG. 3. Computer system 900 includes one or more processors (also called central processing units, or CPUs), such as a processor 904. Processor 904 is connected to a communication infrastructure 906 (e.g., a bus.) Computer system 900 also includes user input/output device(s) 903, such as monitors, keyboards, pointing devices, etc., that communicate with communication infrastructure 906 through user input/output interface(s) 902. Computer system 900 also includes a main or primary memory 908, such as random access memory (RAM). Main memory 908 may include one or more levels of cache. Main memory 908 has stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to some aspects, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 900, main memory 908, secondary memory 910 and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 9. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

1. A user equipment (UE), comprising:
a transceiver configured to wirelessly communicate with a serving cell; and
a processor communicatively coupled to the transceiver and configured to:
receive, using the transceiver and from the serving cell, a first message indicating Physical Random Access Channel (PRACH) resource configuration associated with a neighbor cell;
receive, using the transceiver and from the serving cell, a second message to trigger transmission of a PRACH message to the neighbor cell;
generate, responsive to the second message, the PRACH message according to the PRACH resource configuration associated with the neighbor cell; and
transmit, using the transceiver, the PRACH message to the neighbor cell.

2. The UE of claim 1, wherein the processor is further configured to determine, based on the first message, that the PRACH resource configuration associated with the neighbor cell is same as PRACH resource configuration associated with the serving cell.

3. The UE of claim 1, wherein the processor is further configured to:
determine, based on the first message, a first set of parameters of the PRACH resource configuration associated with the neighbor cell configured by the serving cell; and
determine, based on the first message, that a second set of parameters of the PRACH resource configuration associated with the neighbor cell is same as corresponding set of PRACH resource configuration associated with the serving cell.

4. The UE of claim 1, wherein the processor is further configured to determine a first set of parameters of the PRACH resource configuration associated with the neighbor cell based on System Information Block (SIB) of the neighbor cell.

5. The UE of claim 1, wherein the second message comprises a DCI Format 1_0 comprising a neighbor cell index associated with the neighbor cell, wherein the neighbor cell index comprises a Physical Cell Identifier (PCI) or an identifier (ID) associated with a higher layer configuration for the PRACH resource configuration.

6. The UE of claim 1, wherein the second message comprises a first Physical Downlink Control Channel (PDCCH) message associated with a first Radio Network Temporary Identifier (RNTI) for the neighbor cell and a second PDCCH message associated with a second RNTI associated with a second neighbor cell.

7. The UE of claim 1, wherein the second message comprises one or more of DCI Format 1_0, DCI Format 1_1, or DCI Format 1_2 for indicating a Transmission Configuration Indicator (TCI) associated with the neighbor cell.

8. The UE of claim 1, wherein the second message comprises a Physical Downlink Control Channel (PDCCH) message having a CORESETPoolIndex associated with the neighbor cell for triggering the UE to generate the PRACH message.

9. The UE of claim 1, wherein the second message comprises a plurality of DCI signals to trigger the UE to generate a plurality of PRACH messages to transmit to a plurality of neighbor cells.

10. The UE of claim 1, wherein the second message comprises a Physical Downlink Control Channel (PDCCH) message to trigger the UE to generate a plurality of PRACH messages to transmit to a plurality of neighbor cells.

11. The UE of claim 1, wherein the processor is further configured to receive, using the transceiver, a third message from the neighbor cell, wherein the third message comprises a Timing Advance (TA) determined by the neighbor cell.

12. The UE of claim 1, wherein the processor is further configured to:
receive, using the transceiver, a third message from the serving cell, wherein the third message comprises an indication of a timing group identifier (ID); and
transmit, using the transceiver and to the serving cell, a plurality of uplink signals associated with the timing group ID having same Timing Advance (TA).

13. The UE of claim 12, wherein the third message comprises a TA command Medium Access Control (MAC) Control Element (CE) and wherein the TA command MAC CE comprises the indication of the timing group ID.

14. The UE of claim 1, wherein the processor is further configured to transmit, using the transceiver and to the serving cell, a granularity for Timing Advance (TA) update, wherein the granularity for TA update comprises an amount of time for the UE to change from a first TA associated with a first signal to a second TA associated with a second signal for transmitting the second signal.

15. The UE of claim 14, wherein:
the first signal is associated with a first group of signals and the second signal is associated with a second group of signals,
the first TA is different from the second TA, and
the processor is further configured to transmit, using the transceiver and to the serving cell, the first signal and drop the second signal.

16. The UE of claim 14, wherein:
the first signal is associated with a first group of signals and the second signal is associated with a second group of signals,
the first TA is different from the second TA, and
the processor is further configured to transmit, using the transceiver and to the serving cell, the first signal using the first TA and the second signal using the first TA.

17. The UE of claim 14, wherein:
the first signal is associated with a first group of signals and the second signal is associated with a second group of signals,
the first TA is different from the second TA,
the processor is further configured to transmit, using the transceiver and to the serving cell, the first signal using the first TA and the second signal using the second TA, and
a gap is inserted between the first signal and the second signal.

18. A method, comprising:
receiving, by a user equipment (UE) and from a serving cell, a first message indicating Physical Random Access Channel (PRACH) resource configuration associated with a neighbor cell;
receiving, by the UE and from the serving cell, a second message to trigger transmission of a PRACH message to the neighbor cell;
generating, responsive to the second message, the PRACH message according to the PRACH resource configuration associated with the neighbor cell; and
transmitting the PRACH message to the neighbor cell.

19. The method of claim 18, further comprising:
transmitting, to the serving cell, a granularity for Timing Advance (TA) update,
wherein the granularity for TA update can include an amount of time for the UE to change from a first TA associated with a first signal to a second TA associated with a second signal for transmitting the second signal, and
wherein the first signal is associated with a first group of signals and the second signal is associated with a second group of signals, and the first TA is different from the second TA.

20. A serving cell, comprising:
a transceiver configured to wirelessly communicate with a user equipment (UE); and
a processor communicatively coupled to the transceiver and configured to:
transmit, using the transceiver and to the UE, a first message indicating Physical Random Access Channel (PRACH) resource configuration associated with a neighbor cell; and
transmit, using the transceiver and to the UE, a second message to trigger the UE to transmit the PRACH message to the neighbor cell, wherein the PRACH message is generated responsive to the second message and according to the PRACH resource configuration associated with the neighbor cell.
